(19) United States
(12) Patent Application Publication
(10) Pub. No.: US 2009/0298457 A1
(43) Pub. Date: Dec. 3, 2009

(54) OUTPUT DRIVER CALIBRATION

(76) Inventor: Andreas Jakobs, Munich (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/131,276

(22) Filed: Jun. 2, 2008

(51) Int. Cl. H04B 1/16

(52) U.S. Cl. 455/335; 375/317

(57) ABSTRACT

A method of calibrating an output driver circuit includes providing a comparator to compare drive signals to a reference signal. The reference signal is adjusted to compensate an offset voltage of the comparator. A first drive signal is compared to the adjusted reference signal by the comparator. The first drive signal is adjusted to match the adjusted reference signal, thereby calibrating a first impedance of the output driver circuit.

### BACKGROUND

In electronic systems, information is typically transferred via signals over electric wires. For high frequency operation, the electric impedance of the driver and the receiver should be matched to the electric impedance of the transmission line itself. If the impedances are not matched, a transmitted electromagnetic wave could be reflected at the receiver and possibly again at the driver.

### SUMMARY

One embodiment provides a method of calibrating an output driver circuit. The method includes providing a comparator to compare drive signals to a reference signal. The reference signal is adjusted to compensate an offset voltage of the comparator. A first drive signal is compared to the adjusted reference signal by the comparator. The first drive signal is adjusted to match the adjusted reference signal, thereby calibrating a first impedance of the output driver circuit.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a diagram illustrating a calibration circuit according to one embodiment.

FIG. 2 is a diagram illustrating a calibration circuit with comparator offset voltage compensation according to one embodiment.

FIG. 3 is a flow diagram illustrating a method of calibrating an output driver circuit according to one embodiment.

FIG. 4 is a flow diagram illustrating a method of calibrating an output driver circuit according to another embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

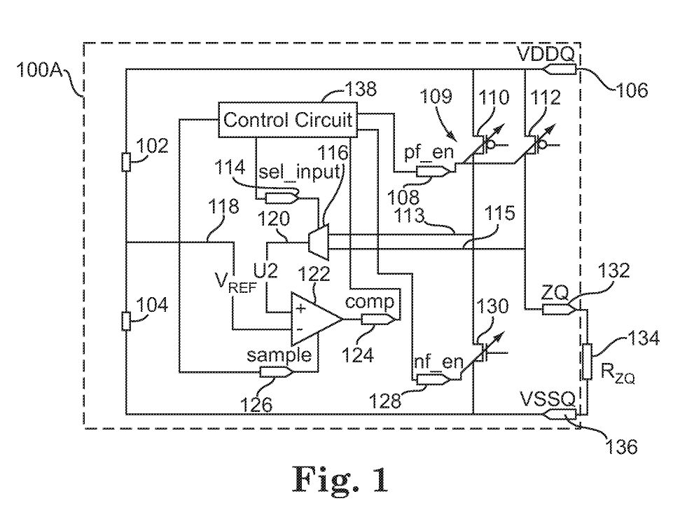

FIG. 1 is a diagram illustrating a calibration circuit 100A according to one embodiment. In one embodiment, circuit 100A is implemented on a DRAM integrated circuit, such as a DDR3 DRAM device, and is configured to perform off-chip driver (OCD) impedance calibration for the DRAM integrated circuit. Calibration circuit 100A includes resistors 102 and 104, transistors 110, 112, and 130, analog multiplexer 116, analog comparator 122, and control circuit (controller) 138. In one embodiment, controller 138 is integrated with circuit 100A. In another embodiment, controller 138 is an external controller. In one embodiment, transistors 110 and 112 are p-channel field effect transistor (PFET) devices that are configured as pull-up transistors, and transistor 130 is an n-channel field effect transistor (NFET) device that is configured as a pull-down transistor. In one embodiment, transistors 110, 112, and 130 form an output driver circuit 109 that produces analog drive signals. Circuit 100A includes a V_{DDQ} voltage supply line 106 and a V_{SSQ} voltage supply line 136 for providing supply voltages (or a supply voltage and ground, respectively) to the circuit 100A. Resistors 102 and 104 are coupled between supply lines 106 and 136. A V_{ref} line 118 is connected to the node between the resistors 102 and 104, and is connected to the negative input of the comparator 122. Transistor 110 is coupled between voltage supply 106 and transistor 130. Transistor 130 is coupled between transistor 110 and voltage supply 136. Transistor 112 is coupled between voltage supply 106 and ZQ pin 132. An external resistor (R_{ZQ}) 134 is coupled between ZQ pin 132 and voltage supply 136. Multiplexer 116 includes a first input coupled via line 113 to a node between transistor 110 and transistor 130, and a second input coupled via line 115 to a node between transistor 112 and ZQ pin 132. Multiplexer 116 includes an output coupled via U2 line 120 to the positive input of comparator 122.

Calibration circuit 100A further includes pf_en input 108, sel_input 114, sample input 126, comp output 124, and nf_en input 128, which are all connected to controller 138. In one embodiment, controller 138 is configured to vary the drive strength of the transistors 110, 112, and 130 using the control inputs 108 and 128, so that the DC impedances of the PFET transistors 110 and 112 (represented by R_{P}) and the NFET transistor 130 (represented by R_{N}) match the resistance of the R_{ZQ} external resistor 134. This is done in one embodiment by driving the external resistor 134 with the PFET transistors 110 and 112, selecting the second input of the multiplexer 116 (coupled to line 115) via sel_input 114, and comparing the level of the resulting analog voltage (U2) on line 120 against the level of an internal reference or target analog voltage (V_{ref}) on line 118. The comparison of U2 against V_{ref} is done in one embodiment by analog comparator 122 (or via an operational amplifier in another embodiment), which is gated by a signal from the controller 138 on the sample input 126. The result of the comparison is fed back to the controller 138 via a result signal on the comp output 124. In one embodiment, the result signal has either a first state or a second state based on whether the signal level of U2 exceeds the signal level of V_{ref}.

In one embodiment, resistors 102 and 104 have equal resistance values and the internal reference voltage (V_{ref}) is equal to half of the supply voltage V_{DDQ}. The value for the voltage (U2) output by multiplexer 116 is given in the following Equation I:

U2=V_{DDQ}(R_{ZQ}/(R_{P}+R_{ZQ})) Equation I
Where:
   U2=voltage at the output of the multiplexer 116;
   V_{DDQ}=supply voltage;
   R_{ZQ}=resistance of external resistor 134; and
   R_{P}=impedance of PFET transistor.

In one embodiment, the PFET transistors 110 and 112 are controlled by controller 138 via pf_en input 108 to produce a voltage (U2) that matches or is equal to the reference voltage (V_{ref}), and equal DC impedances for the PFET transistors (R_{P}) and the external resistor 134 (R_{ZQ}), as shown in the following Equation II:

U2=V_{ref}=V_{DDQ}/2→R_{P}=R_{ZQ} Equation II
Where:
   U2=voltage at the output of the multiplexer 116;
   V_{ref}=reference voltage at the negative input of the comparator 122;
   V_{DDQ}=supply voltage;
   R_{P}=impedance of PFET transistor; and
   R_{ZQ}=resistance of external resistor 134.

In one embodiment, the pf_en signal and nf_en signal are analog signals that control the gate voltage of transistors 110, 112, and 130. In another embodiment, transistors 110, 112, and 130 are each implemented with a plurality of differently sized transistors that are connected in parallel, and the pf_en and nf_en signals are multiple-bit digital signals or digital control words (with each bit enabling or disabling a corresponding one of the parallel connected transistors). In one embodiment, the pf_en and nf_en controls signals generated by controller 138 each have a predetermined duration, and these signals are varied (e.g., increased or decreased) by predetermined amounts or step sizes. Controller 138 varies the control signals based on the result signal output by comparator 122 on comp output 124.

In one embodiment, transistors 110 and 112 are each implemented with five PFET transistors connected in parallel (also referred to as PFET fingers), which are controlled via input 108 using a 5-bit pf_en control signal (pf_en[4:0]) from controller 138. In one form of this embodiment, the widths (W) of the PFET transistors each increases by a factor of two (e.g., 1, 2, 4, 8, and 16 μm). Each of the five PFET transistors is controlled (e.g., enabled or disabled) by a corresponding one of the bits in the five-bit control signal on pf_en input 108, with the most-significant bit (MSB) of the control signal corresponding to the largest transistor (e.g., 16 μm), and the least-significant bit (LSB) of the control signal corresponding to the smallest transistor (e.g., 1 μm).

In one embodiment, controller 138 is configured to use a binary search algorithm (also referred to as a bisection algorithm or a successive approximation algorithm) that varies the binary weighted bits of pf_en from MSB to LSB and evaluates the output of comparator 122 (i.e., the value on comp output 124). An advantage of this algorithm according to one embodiment is that its time complexity grows only with log₂(N), where N is the total number of steps (i.e., the resolution).

As an example, assume that a static impedance of 240 Ohms is desired for the PFET transistors, which corresponds to a transistor width of 10.7 μm. In one embodiment, controller 138 will first set the MSB of the pf_en signal (i.e., pf_en=10000, W=16), and comparator 122 will output a high signal (i.e., comp=1), indicating that U2 is too high. Controller 138 will then reset bit four (i.e., the MSB) and set bit three (i.e., pf_en=01000, W=8), and comparator 122 will output a low signal (i.e., comp=0), indicating that U2 is too low. Controller 138 will then keep the value for bit three and set bit two (i.e., pf_en=01100, W=12), and comparator 122 will output a high signal (i.e., comp=1), indicating that U2 is too high. Controller 138 will then reset bit two and set bit one (i.e., pf_en=01010, W=10), and comparator 122 will output a low signal (i.e., comp=0), indicating that U2 is too low. Controller 138 will then keep the value for bit one and set bit zero (i.e., pf_en=01011, W=11), and comparator 122 will output a high signal (i.e., comp=1), indicating that U2 is too high. In one embodiment, controller 138 will then keep the value for bit zero, and in another embodiment, bit zero is reset.

In one embodiment, PFET transistor 112 is calibrated as described above, and then the determined calibration parameters are copied to PFET transistor 110 (e.g., the final pf_en signal that is determined for transistor 112 is applied to transistor 110). After the PFET transistors 110 and 112 have been calibrated, the NFET transistor 130 is calibrated. The first input of the multiplexer 116 (coupled to line 113) is selected via sel_input 114. The NFET transistor 130 is varied by controller 138 via nf_en input 128, and the resulting voltage (U2′) is compared against the internal reference voltage (V_{ref}) by comparator 122. The result of the comparison is fed back to the controller 138 via the comp output 124. The value for the voltage (U2′) output by multiplexer 120 is given in the following Equation III:

U2′=V_{DDQ}(R_{N}/(R_{P}+R_{N})) Equation III
Where:
   U2′=voltage at the output of the multiplexer 116;
   V_{DDQ}=supply voltage;
   R_{N}=impedance of NFET transistor; and
   R_{P}=impedance of PFET transistor.

In one embodiment, the NFET transistor 130 is controlled by controller 138 via nf_en input 128 to produce a voltage (U2′) that is equal to the reference voltage (V_{ref}), and equal DC impedances for the PFET transistors (R_{P}), NFET transistor (R_{N}), and the external resistor 134 (R_{ZQ}), as shown in the following Equation IV:

U2′=V_{ref}=V_{DDQ}/2→R_{N}=R_{P}=R_{ZQ} Equation IV
Where:
   U2′=voltage at the output of the multiplexer 116;
   V_{ref}=reference voltage at the negative input of the comparator 122;
   V_{DDQ}=supply voltage;
   R_{N}=impedance of NFET transistor;
   R_{P}=impedance of PFET transistor; and
   R_{ZQ}=resistance of external resistor 134.

Analog comparators, such as comparator 122, are typically not free of offset voltages (e.g., due to device mismatch), so the output does not typically switch when the inputs become equal. The intrinsic offset voltage, Δ, of comparator 122 according to one embodiment represents the magnitude difference between the two input voltages that will cause the comparator 122 to switch states (i.e., the comparator 122 will not switch states if the difference between the two inputs is less than Δ, but the comparator 122 will switch states if the difference between the two inputs becomes equal to or greater than Δ. The offset voltage of comparator 122 translates into a calibration error for the DC impedance of the PFET transistors (R_{P}) as shown by the following Equation V:

U2=V_{ref}+Δ→R_{P}=R_{ZQ}(1/(1+(2Δ/V_{DDQ}))) Equation V
Where:
   U2=voltage at the output of the multiplexer 116;
   V_{ref}=reference voltage at the negative input of the comparator 122;
   Δ=intrinsic offset voltage of comparator 122;
   R_{P}=impedance of PFET transistor;
   R_{ZQ}=resistance of external resistor 134; and
   V_{DDQ}=supply voltage.

Equation V indicates that the intrinsic comparator offset voltage, Δ, has the same effect as a linear error in the reference voltage, V_{ref}. The effect of the offset voltage can be compensated by modifying the reference voltage V_{ref} to produce the equality shown in the following Equation VI:

V_{ref}+Δ=V_{DDQ}/2 Equation VI
Where:
   V_{ref}=reference voltage at the negative input of the comparator 122;
   Δ=intrinsic offset voltage of comparator 122; and
   V_{DDQ}=supply voltage.

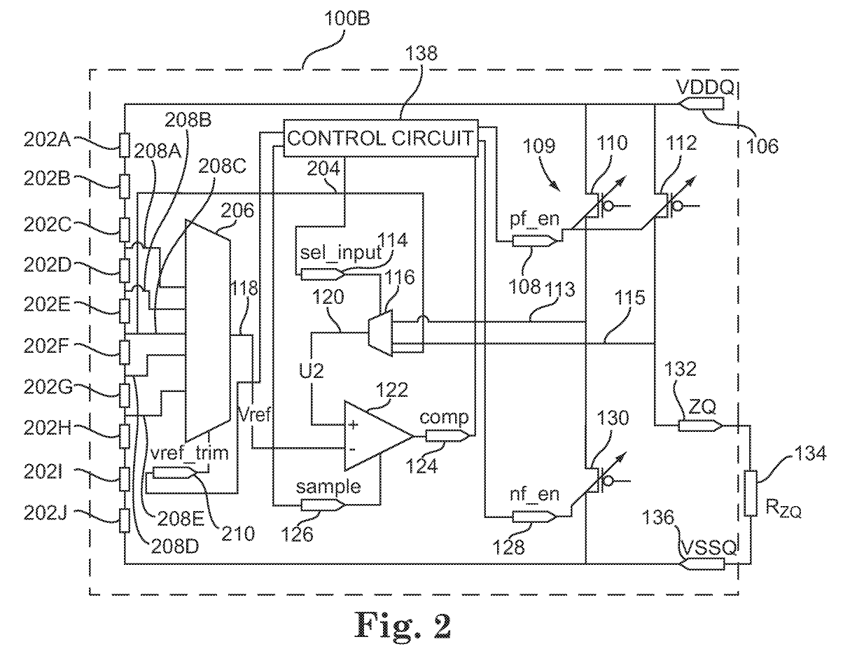

FIG. 2 is a diagram illustrating a calibration circuit 100B with comparator offset voltage compensation according to one embodiment. In one embodiment, circuit 100B is implemented on a DRAM integrated circuit, such as a DDR3 DRAM device, and is configured to perform OCD impedance calibration for the DRAM integrated circuit. Calibration circuit 100B includes resistors 202A-202J (collectively referred to as resistors 202), analog multiplexer 206, transistors 110, 112, and 130, analog multiplexer 116, analog comparator 122, and control circuit (controller) 138. In the illustrated embodiment, calibration circuit 100B includes the same elements as calibration circuit 100A (FIG. 1), but also adds more resistors 202 (as opposed to the two resistors 102 and 104 shown in FIG. 1) and a multiplexer 206 coupled to the resistors 202.

Resistors 202A-202J are coupled in series between supply lines 106 and 136, and form a voltage divider network. A tap line 208A is coupled to the node between resistors 202C and 202D, and is coupled to a first input of multiplexer 206. A tap line 208B is coupled to the node between resistors 202D and 202E, and is coupled to a second input of multiplexer 206. A tap line 208C is coupled to the node between resistors 202E and 202F, and is coupled to a third input of multiplexer 206. A tap line 208D is coupled to the node between resistors 202F and 202G, and is coupled to a fourth input of multiplexer 206. A tap line 208E is coupled to the node between resistors 202G and 202H, and is coupled to a fifth input of multiplexer 206. Tap lines 208A-208E are collectively referred to as tap lines 208. In other embodiments, circuit 100B may include more or less than ten resistors 202 and more or less than five tap lines 208. V_{ref} line 118 is connected between an output of the multiplexer 206 and the negative input of the comparator 122.

Multiplexer 116 includes a first input coupled via line 113 to a node between transistor 110 and transistor 130, a second input coupled via line 115 to a node between transistor 112 and ZQ pin 132, a third input coupled via line 204 to the node between resistors 202E and 202F, and an output coupled via line 120 to the positive input of the comparator 122. In one embodiment, the node between resistors 202E and 202F is at the center of the voltage divider network formed by resistors 202, and has a voltage level of V_{DDQ}/2. Thus, in the illustrated embodiment, the voltage at the third input of multiplexer 116 is equal to half of the supply voltage V_{DDQ}.

In one embodiment, multiplexer 116 is configured to receive a first drive signal from a pull-down device (e.g., device 130) on the first input via line 113, receive a second drive signal from a pull-up device (e.g., devices 110 and 112) on the second input via line 115, and receive a fixed or constant signal on the third input via line 204. In one embodiment, controller 138 is configured to control the multiplexer 116 to output the fixed signal from line 204 to the comparator 122 during comparator offset compensation, output the drive signals from line 115 to the comparator 122 during impedance calibration of the pull-up device, and output the drive signals from line 113 to the comparator 122 during impedance calibration of the pull-down device.

Multiplexer 206 according to one embodiment makes the V_{ref} signal on line 118 variable during comparator offset compensation by selection of different ones of the tap lines 208. In one embodiment, the taps are narrowly “spaced” to give a high resolution (i.e., there is a relatively small voltage difference between adjacent tap lines 208). In one embodiment, the voltage difference between each adjacent set of tap lines 208 is about 10 mV. The selection of a tap line 208 is made by controller 138 via a vref_trim input 210 of multiplexer 206. The voltage on a selected tap line 208 is output from multiplexer 206 through V_{ref} line 118 to the negative input of the comparator 122.

In one embodiment, the offset voltage of comparator 122 is compensated prior to the calibration of the driver impedances. As described above with respect to FIG. 1, during the calibration of the driver impedances according to one embodiment, the reference voltage on line 118, V_{ref}, is held constant, and the voltage on line 120, U2, is varied, until a match between these voltages occurs. In contrast, during the compensation of the comparator offset voltage according to one embodiment, the voltage on line 120, U2, is held constant, and the reference voltage on line 118, V_{ref}, is varied. During the comparator offset compensation process according to one embodiment, controller 138 uses sel_input 114 to select the third input of multiplexer 116, which is coupled to line 204. This causes multiplexer 116 to output a voltage of V_{DDQ}/2 on U2 line 120. Solving Equation V for V_{ref} and substituting the value V_{DDQ}/2 for U2 results in the following Equation VII:

V_{ref}=U2−Δ=(V_{DDQ}/2)−Δ Equation VII
Where:
   V_{ref}=reference voltage at the negative input of the comparator 122;
   U2=voltage at the output of the multiplexer 116;
   Δ=intrinsic offset voltage of comparator 122; and
   V_{DDQ}=supply voltage.

By using a reference voltage, V_{ref}, that satisfies Equation VII, the offset voltage of the comparator 122 will be compensated. This value for the reference voltage, V_{ref}, is produced in one embodiment by first selecting tap line 208C of multiplexer 206. The voltage on V_{ref} line 118 is then gradually lowered in steps by selecting the next adjacent tap line 208 in each step (e.g., selecting tap line 208D, and then selecting tap line 208E) until the comparator 122 switches states. Controller 138 selects the tap lines 208 in each step using vref_trim input 210. When comparator 122 switches states, the reference voltage, V_{ref}, will be equal to half of the supply voltage, V_{DDQ}, minus the comparator offset voltage, Δ. This means that the reference voltage V_{ref} has been lowered by the amount of the comparator offset Δ. In one embodiment, this modified V_{ref} is then used to perform the driver impedance calibration as described above with respect to FIG. 1. By using the modified reference voltage, the voltage offset of comparator 122 is compensated as shown by the following Equation VIII:

U2=V_{DDQ}(R_{ZQ}/(R_{P}+R_{ZQ}))=V_{ref}+Δ=((V_{DDQ}/2)−Δ)+Δ=V_{DDQ}/2→R_{P}=R_{ZQ} Equation VIII
Where:
   U2=voltage at the output of the multiplexer 116;
   V_{DDQ}=supply voltage;
   R_{ZQ}=resistance of external resistor 134;
   R_{P}=impedance of PFET transistor;
   V_{ref}=reference voltage at the negative input of the comparator 122; and
   Δ=intrinsic offset voltage of comparator 122.

In one embodiment, calibration circuit 100B is configured to perform the comparator offset compensation described above each time that circuit 100B is powered-up or initialized. In another embodiment, calibration circuit 100B is configured to perform the comparator offset compensation described above prior to the start of each impedance calibration sequence.

In one embodiment, circuit 100B is configured to produce an intended offset that results in a drive signal that is stronger or weaker than the drive signal without the intended offset. In one embodiment, the circuit 100B first modifies the reference voltage, V_{ref}, to compensate the offset voltage of the comparator 122, and then uses the modified reference voltage for the impedance calibration, and then modifies or adjusts the modified reference voltage to increase or decrease a drive strength of the circuit 100B.

In one embodiment, circuit 100B is implemented in an integrated circuit memory, and includes a reference signal generator circuit (e.g., resistors 202, tap lines 208, and multiplexer 206) configured to generate a reference signal, an output driver circuit 109 configured to output a drive signal, and a compare circuit (e.g., comparator 122) configured to compare the drive signal and the reference signal. In one embodiment, circuit 100B also includes a control circuit 138 configured to modify the reference signal while holding the drive signal constant to compensate an offset voltage of the compare circuit 122, and configured to modify the drive signal while holding the modified reference signal constant to calibrate an impedance of the output driver circuit 109.

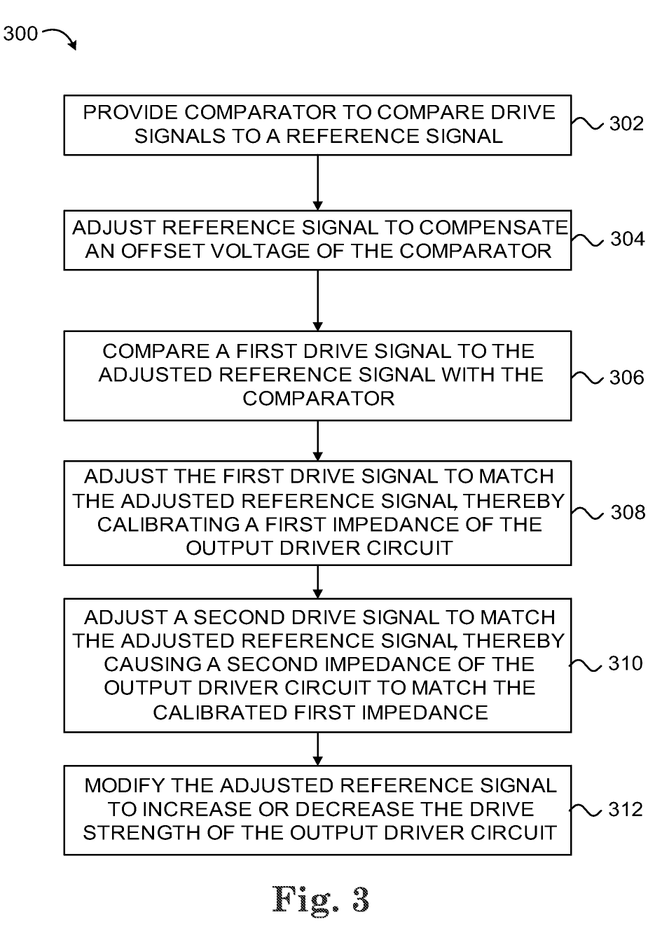

FIG. 3 is a flow diagram illustrating a method 300 of calibrating an output driver circuit according to one embodiment. In one embodiment, circuit 100B is configured to perform method 300. At 302, a comparator 122 is provided to compare drive signals to a reference signal. At 304, the reference signal is adjusted by the circuit 100B to compensate an offset voltage of the comparator 122. At 306, the comparator 122 compares a first drive signal to the adjusted reference signal. At 308, the first drive signal is adjusted to match the adjusted reference signal, thereby calibrating a first impedance of the output driver circuit. In one embodiment, the adjustment at 308 causes the first impedance to match an impedance of external resistor 134. At 310, a second drive signal is adjusted to match the adjusted reference signal, thereby causing a second impedance of the output driver circuit to match the calibrated first impedance. At 312, the adjusted reference signal is modified to increase or decrease the drive strength of the output driver circuit 109.

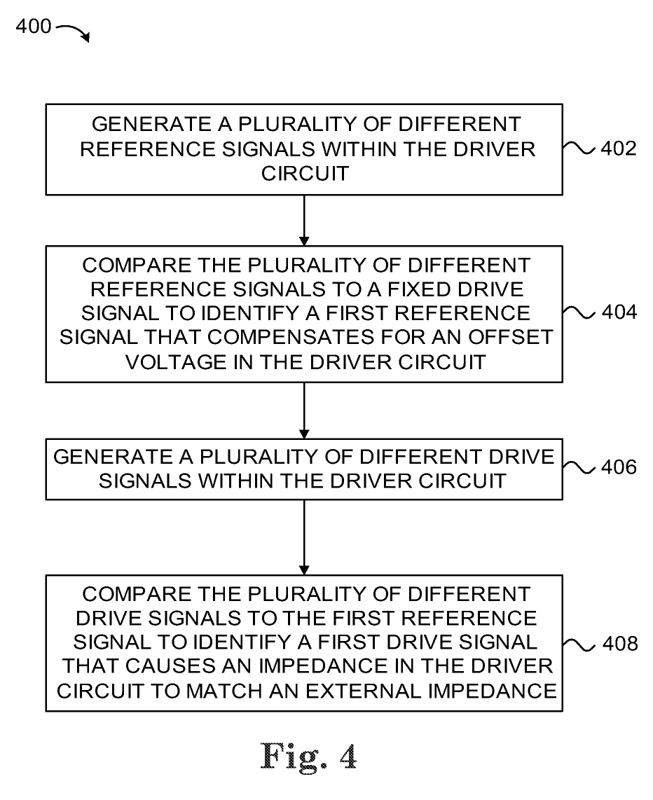

FIG. 4 is a flow diagram illustrating a method 400 of calibrating an output driver circuit according to another embodiment. In one embodiment, circuit 100B is configured to perform method 400. At 402, a plurality of different reference signals are generated within the driver circuit. At 404, the plurality of different reference signals are compared to a fixed drive signal to identify a first reference signal that compensates for an offset voltage in the driver circuit. At 406, a plurality of different drive signals are generated within the driver circuit. At 408, the plurality of different drive signals are compared to the first reference signal to identify a first drive signal that causes an impedance in the driver circuit to match an external impedance.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of calibrating an output driver circuit, the method comprising:
providing a comparator to compare drive signals to a reference signal;
adjusting the reference signal to compensate an offset voltage of the comparator;
comparing a first drive signal to the adjusted reference signal with the comparator; and
adjusting the first drive signal to match the adjusted reference signal, thereby calibrating a first impedance of the output driver circuit.

2. The method of claim 1, wherein adjusting the first drive signal to match the adjusted reference signal causes the first impedance to match an impedance of an external resistor.

3. The method of claim 1, and further comprising:
adjusting a second drive signal to match the adjusted reference signal, thereby causing a second impedance of the output driver circuit to match the calibrated first impedance.

4. The method of claim 1, and further comprising:
modifying the adjusted reference signal to increase or decrease a drive strength of the output driver circuit.

5. The method of claim 1, wherein the adjusting of the reference signal is performed at power-up of the output driver circuit.

6. The method of claim 1, wherein the adjusting of the reference signal is performed prior to each impedance calibration sequence of the output driver circuit.

7. The method of claim 1, and further comprising:
providing a multiplexer with a first input configured to receive the first drive signal, a second input configured to receive a second drive signal, a third input configured to receive a fixed signal, and an output coupled to a first input of the comparator; and
controlling the multiplexer to output the fixed signal to the first input of the comparator.

8. The method of claim 7, and further comprising:
outputting the reference signal to a second input of the comparator.

9. The method of claim 8, wherein the adjusting of the reference signal comprises adjusting the reference signal at the second input of the comparator until the comparator switches states.

10. An integrated circuit memory, comprising:
a reference signal generator circuit configured to generate a reference signal;
an output driver circuit configured to output a drive signal;
a compare circuit configured to compare the drive signal and the reference signal; and
a control circuit configured to modify the reference signal while holding the drive signal constant to compensate an offset voltage of the compare circuit, and configured to modify the drive signal while holding the modified reference signal constant to calibrate an impedance of the output driver circuit.

11. The integrated circuit memory of claim 10, wherein the output driver circuit comprises a pull-up device and a pull-down device.

12. The integrated circuit memory of claim 11, wherein at least one of the pull-up device and the pull-down device comprises a plurality of differently sized transistors coupled in parallel, wherein the control circuit is configured to generate multiple-bit control signals to modify the drive signal, and wherein the control signals are configured to enable and disable selected ones of the parallel connected transistors.

13. The integrated circuit memory of claim 11, and further comprising:
a multiplexer with a first input coupled to the pull-down device, a second input coupled to the pull-up device, a third input coupled to a fixed signal, and an output coupled to the compare circuit.

14. The integrated circuit memory of claim 13, wherein the control circuit is configured to cause the multiplexer to output the fixed signal from the third input of the multiplexer during compensation of the offset voltage.

15. The integrated circuit memory of claim 14, wherein the control circuit is configured to cause the multiplexer to output a signal from the second input of the multiplexer during an impedance calibration of the pull-up device, and cause the multiplexer to output a signal from the first input of the multiplexer during an impedance calibration of the pull-down device.

16. The integrated circuit memory of claim 10, wherein the control circuit is configured to adjust the modified reference signal to increase or decrease a drive strength of the output driver circuit.

17. The integrated circuit memory of claim 10, wherein the integrated circuit memory comprises a DDR3 DRAM memory device.

18. A method of calibrating a driver circuit, the method comprising:
generating a plurality of different reference signals within the driver circuit;
comparing the plurality of different reference signals to a fixed drive signal to identify a first reference signal that compensates for an offset voltage in the driver circuit;
generating a plurality of different drive signals within the driver circuit; and
comparing the plurality of different drive signals to the first reference signal to identify a first drive signal that causes an impedance in the driver circuit to match an external impedance.

19. The method of claim 18, and further comprising:
modifying the first reference signal to increase or decrease a drive strength of the driver circuit.

20. The method of claim 18, and further comprising:
providing a multiplexer with a first input coupled to a pull-down device of the driver circuit, a second input coupled to a pull-up device of the driver circuit, and a third input coupled to a fixed signal; and
controlling the multiplexer to output the fixed signal during an offset voltage compensation process and the plurality of different drive signals during an impedance calibration process.
